(19) United States
(12) Patent Application Publication
(10) Pub. No.: US 2024/0212520 A1
(43) Pub. Date: Jun. 27, 2024

(54) SYSTEM FOR LOWERING COSTS AND IMPROVING ACCESS TO DRIVER EDUCATION USING TELEMATICS

(71) Applicant: Grange Holdings Inc., Columbus, OH (US)

(72) Inventors: Jason L. Wrather, Columbus, OH (US); Brent Hammer, Columbus, OH (US)

(21) Appl. No.: 18/087,188

(22) Filed: Dec. 22, 2022

(51) Int. Cl. G09B 19/16; G06Q 40/08; G07C 5/04

(52) U.S. Cl. CPC G09B 19/167; G06Q 40/08; G07C 5/04; G09B 7/00

(57) ABSTRACT

Systems and methods for lowering costs and improving access to driver education and automobile insurance for teens, using telematics technology. The method comprises downloading a driver training application; activating an in-classroom learning module in the application; activating a parent training practice module in the application specific to the jurisdiction's hour requirement for supervised driving that uses telematics tracking software to evaluate and score the driver's driving in real time; activating an in-car driving module in the application specific to the jurisdiction's hour requirement for in-car driving that uses the telematics tracking software to collects and score the driver's driving data in real time; completing the jurisdiction's driving exam; earning the jurisdiction's driver license; and receiving an automobile insurance quote generated from a proprietary teen driver insurance score.

### BACKGROUND

The disclosed technology relates in general to systems and methods for obtaining a driver license and automobile insurance, and more specifically to a system and method for lowering costs and improving access to driver education, training, and automobile insurance for teenagers and other individuals, using telematics technologies and application software technology.

Each year, millions of teenagers and other individuals attempt to navigate the complex and expensive process of obtaining a driver license and required automobile insurance. The current driver license process has remained unchanged for over 25 years and continues to utilize a very manual and subjective process for training and evaluating driver skills. Consumers typically do not have many options and must continue to pay high prices and endure limited training availability to fulfill the education and training requirements for a driver license. Similar challenges also exist with regard to obtaining automobile insurance with high prices and limited options being common obstacles encountered by teenagers and other individuals.

Thus, what is needed is an innovative systematic approach that will utilize and leverage telematics technologies and focus on lowering the cost of, and improving access to, the education and driver training needed to obtain a driver license and automobile insurance. A robust ecosystem of services can then be developed to support the surrounding needs of the teenage driver and their family throughout their lifecycle.

### SUMMARY

The following provides a summary of certain example implementations of the disclosed technology. This summary is not an extensive overview and is not intended to identify key or critical aspects or elements of the disclosed technology or to delineate its scope. However, it is to be understood that the use of indefinite articles in the language used to describe and claim the disclosed technology is not intended in any way to limit the described technology. Rather the use of “a” or “an” should be interpreted to mean “at least one” or “one or more.”

One implementation of the disclosed technology provides a system for improving access to teen driver education and automobile insurance using telematics technology, comprising: a downloadable driver training application, wherein a driver selects and submits a fee for training modules offered within the application, wherein the driver enters an access code to access the modules; an in-classroom learning module within the application that grants an in-classroom training certificate upon completion, wherein the driver is presented with readings, videos, and validation questions that are specific to a jurisdictional in-classroom hour and content requirement needed to obtain a driver license; a parent training practice module within the application specific to the jurisdiction's hour requirement for supervised driving that grants a parent practice certificate upon completion, wherein telematics tracking software evaluates and scores the driver's driving in real time along a generated route for a driver-selected practice skill; an in-car driving module within the application specific to the jurisdiction's hour requirement for in-car driving that grants an evaluation certificate upon completion, wherein the telematics tracking software collects and scores the driver's driving data in real time along the generated route; a jurisdictional driving exam that is completed by the driver; a jurisdictional driver license that is earned by the driver; and an automobile insurance quote generated from a proprietary teen driver insurance score that is calculated based on the driver's performance in the in-classroom leaning module or from the driving data collected by the telematics tracking software and received by the driver.

Further describing the system, the training application is a downloadable mobile application or an in-vehicle application systems. The validation questions of the in-classroom learning module are recorded and scored within the application, wherein the readings, videos, and validation questions repeat if the driver answers the validation questions incorrectly. The in-classroom training certificate of the in-classroom learning module is electronically transmitted to the jurisdiction if the jurisdiction participates in electronic reporting, or if the jurisdiction does not participate in electronic reporting, the in-classroom training certificate is generated into downloadable PDF format for the driver to submit to the jurisdiction. The telematics tracking software in the parent training practice module records and analyzes the driver's driving history and determines whether the driver obtained a passing score for the selected practice skill, wherein the selected practice skill is recorded as “complete” if the driver obtained the passing score, wherein the driver must repeat the selected practice skill if the driver did not obtain the passing score. The generated route in the parent training practice module can use safe route detection, wherein, the application analyzes safe and unsafe roads along route options, scores the route options based upon their safety, and selects the safest route for the driver's practice. The application examines rates of accidents, weather and road conditions, construction and lane closures, and traffic patterns to determine the safe and unsafe roads when selecting the safest route for the driver's practice. The parent practice certificate of the parent training practice module is electronically transmitted to the jurisdiction if the jurisdiction participates in electronic reporting, or if the jurisdiction does not participate in electronic reporting, the parent practice certificate is generated into downloadable PDF format for the driver to submit to the jurisdiction. The in-car driving module can use safe route detection, wherein, the application analyzes safe and unsafe roads along route options, scores the route options based upon their safety, and selects the safest route for the driver. The telematics tracking software's score in the in-car driving module is evaluated against the jurisdiction's requirements for a passing result, wherein a teen driver report is generated in alignment with the jurisdiction's requirements if the telematics tracking software's score is passing, wherein the driver must repeat the in-car driving module if the score is not passing. The evaluation certificate of the in-car driving module is electronically transmitted to the jurisdiction if the jurisdiction participates in electronic reporting, or if the jurisdiction does not participate in electronic reporting, the evaluation certificate is generated into downloadable PDF format for the driver to submit to the jurisdiction. The automobile insurance quote can be selected by the driver within the application from a list of insurance companies, wherein the driver selects their desired company(s) for the quote, wherein the proprietary teen driver insurance score and the driver's vehicle data is transferred to the company(s), wherein the company(s) quote a policy and issue a rate that is displayed within the application, wherein the driver selects their desired company and purchases the automobile insurance. Finally, a referral fee is administered to an entity if the access code was supplied by the entity.

Another implementation of the disclosed technology provides a method for improving access to teen driver education and automobile insurance using telematics technology. The method comprises downloading a driver training application, wherein a driver selects and submits a fee for training modules offered within the application, wherein the driver enters an access code to access the modules; activating an in-classroom learning module in the application that grants an in-classroom training certificate upon completion, wherein the driver is presented with readings, videos, and validation questions that are specific to a jurisdictional in-classroom hour and content requirement needed to obtain a driver license; activating a parent training practice module in the application specific to the jurisdiction's hour requirement for supervised driving that grants a parent practice certificate upon completion, wherein telematics tracking software evaluates and scores the driver's driving in real time along a generated route for a driver-selected practice skill; activating an in-car driving module in the application specific to the jurisdiction's hour requirement for in-car driving that grants an evaluation certificate upon completion, wherein the telematics tracking software collects and scores the driver's driving data in real time along the generated route; completing the jurisdiction's driving exam; earning the jurisdiction's driver license; and receiving an automobile insurance quote generated from a proprietary teen driver insurance score that is calculated by the driver's performance in the in-classroom leaning module or from the driving data collected by the telematics tracking software.

Further describing the method, the training application is a downloadable mobile application or an in-vehicle application systems. The validation questions of the in-classroom learning module are recorded and scored within the application, wherein the readings, videos, and validation questions repeat if the driver answers the validation questions incorrectly. The in-classroom training certificate of the in-classroom learning module is electronically transmitted to the jurisdiction if the jurisdiction participates in electronic reporting, or if the jurisdiction does not participate in electronic reporting, the in-classroom training certificate is generated into downloadable PDF format for the driver to submit to the jurisdiction. The telematics tracking software in the parent training practice module records and analyzes the driver's driving history and determines whether the driver obtained a passing score for the selected practice skill, wherein the selected practice skill is recorded as “complete” if the driver obtained the passing score, wherein the driver must repeat the selected practice skill if the driver did not obtain the passing score. The generated route in the parent training practice module can use safe route detection, wherein, the application analyzes safe and unsafe roads along route options, scores the route options based upon their safety, and selects the safest route for the driver's practice. The application examines rates of accidents, weather and road conditions, construction and lane closures, and traffic patterns to determine the safe and unsafe roads when selecting the safest route for the driver's practice. The parent practice certificate of the parent training practice module is electronically transmitted to the jurisdiction if the jurisdiction participates in electronic reporting, or if the jurisdiction does not participate in electronic reporting, the parent practice certificate is generated into downloadable PDF format for the driver to submit to the jurisdiction. The in-car driving module can use safe route detection, wherein, the application analyzes safe and unsafe roads along route options, scores the route options based upon their safety, and selects the safest route for the driver. The telematics tracking software's score in the in-car driving module is evaluated against the jurisdiction's requirements for a passing result, wherein a teen driver report is generated in alignment with the jurisdiction's requirements if the telematics tracking software's score is passing, wherein the driver must repeat the in-car driving module if the score is not passing. The evaluation certificate of the in-car driving module is electronically transmitted to the jurisdiction if the jurisdiction participates in electronic reporting, or if the jurisdiction does not participate in electronic reporting, the evaluation certificate is generated into downloadable PDF format for the driver to submit to the jurisdiction. The automobile insurance quote can be selected by the driver within the application from a list of insurance companies, wherein the driver selects their desired company(s) for the quote, wherein the proprietary teen driver insurance score and the driver's vehicle data is transferred to the company(s), wherein the company(s) quote a policy and issue a rate that is displayed within the application, wherein the driver selects their desired company and purchases the automobile insurance. Finally, a referral fee is administered to an entity if the access code was supplied by the entity.

Another implementation of the disclosed technology provides a method for lowering the costs of teen driver education and automobile insurance using telematics technology. The method comprises downloading a driver training application, wherein a driver selects and submits a fee for training modules offered within the application, wherein the driver enters an access code to access the modules; activating an in-classroom learning module in the application that grants an in-classroom training certificate upon completion, wherein the driver is presented with readings, videos, and validation questions that are specific to a jurisdiction's in-classroom hour and content requirement needed to obtain a driver license, wherein the in-classroom training certificate is electronically transmitted to the jurisdiction if the jurisdiction participates in electronic reporting, or if the jurisdiction does not participate in electronic reporting, the in-classroom training certificate is generated into downloadable PDF format for the driver to submit to the jurisdiction; activating a parent training practice module in the application specific to the jurisdiction's hour requirement for supervised driving that grants a parent practice certificate upon completion, wherein telematics tracking software evaluates and scores the driver's driving in real time along a generated route for a driver-selected practice skill, wherein the parent practice certificate is electronically transmitted to the jurisdiction if the jurisdiction participates in electronic reporting, or if the jurisdiction does not participate in electronic reporting, the parent practice certificate is generated into downloadable PDF format for the driver to submit to the jurisdiction; activating an in-car driving module in the application specific to the jurisdiction's hour requirement for in-car driving that grants an evaluation certificate upon completion, wherein the telematics tracking software collects and scores the driver's driving data in real time along the generated route, wherein the evaluation certificate is electronically transmitted to the jurisdiction if the jurisdiction participates in electronic reporting, or if the jurisdiction does not participate in electronic reporting, the evaluation certificate is generated into downloadable PDF format for the driver to submit to the jurisdiction; completing the jurisdiction's driving exam; earning the jurisdiction's driver license; and receiving an automobile insurance quote generated from a proprietary teen driver insurance score that is calculated by the driver's performance in the in-classroom leaning module or from the driving data collected by the telematics tracking software.

Further describing the method, the training application is a downloadable mobile application or an in-vehicle application systems. The validation questions of the in-classroom learning module are recorded and scored within the application, wherein the readings, videos, and validation questions repeat if the driver answers the validation questions incorrectly. The telematics tracking software in the parent training practice module records and analyzes the driver's driving history and determines whether the driver obtained a passing score for the selected practice skill, wherein the selected practice skill is recorded as “complete” if the driver obtained the passing score, wherein the driver must repeat the selected practice skill if the driver did not obtain the passing score. The generated route in the parent training practice module can use safe route detection, wherein, the application analyzes safe and unsafe roads along route options, scores the route options based upon their safety, and selects the safest route for the driver's practice. The application examines rates of accidents, weather and road conditions, construction and lane closures, and traffic patterns to determine the safe and unsafe roads when selecting the safest route for the driver's practice. The parent training practice module utilizes the driver's geolocation. The in-car driving module can use safe route detection, wherein, the application analyzes safe and unsafe roads along route options, scores the route options based upon their safety, and selects the safest route for the driver. The telematics tracking software's score in the in-car driving module is evaluated against the jurisdiction's requirements for a passing result, wherein a teen driver report is generated in alignment with the jurisdiction's requirements if the telematics tracking software's score is passing, wherein the driver must repeat the in-car driving module if the score is not passing. The automobile insurance quote can be selected by the driver within the application from a list of insurance companies, wherein the driver selects their desired company(s) for the quote, wherein the proprietary teen driver insurance score and the driver's vehicle data is transferred to the company(s), wherein the company(s) quote a policy and issue a rate that is displayed within the application, wherein the driver selects their desired company and purchases the automobile insurance. Finally, a referral fee is administered to an entity if the access code was supplied by the entity.

It should be appreciated that all combinations of the foregoing concepts and additional concepts discussed in greater detail below (provided such concepts are not mutually inconsistent) are contemplated as being part of the technology disclosed herein and may be implemented to achieve the benefits as described herein. Additional features and aspects of the disclosed system, devices, and methods will become apparent to those of ordinary skill in the art upon reading and understanding the following detailed description of the example implementations. As will be appreciated by the skilled artisan, further implementations are possible without departing from the scope and spirit of what is disclosed herein. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more example implementations of the disclosed technology and, together with the general description given above and detailed description given below, serve to explain the principles of the disclosed subject matter, and wherein:

FIG. 1 is a process flow diagram illustrating an example main workflow for lowering costs and improving access to driver education and automobile insurance for teenagers, using telematics and application software technology;

FIG. 2 is a process flow diagram illustrating an example stepwise activation of premium features within an application;

FIG. 3 is a process flow diagram illustrating an example stepwise progression within a classroom learning module;

FIG. 4 is a process flow diagram illustrating an example stepwise generation of a classroom training certificate;

FIG. 5A is a process flow diagram illustrating an example stepwise progression within an example parent training practice module;

FIG. 5B is a process flow diagram illustrating an example stepwise route guidance and safe route detection within a parent training practice module;

FIG. 6 is a process flow diagram illustrating an example stepwise generation of a parent practice certificate;

FIG. 7A is a process flow diagram illustrating an example stepwise in-car driving evaluation;

FIG. 7B is a process flow diagram illustrating an example stepwise decision process for determining whether a teenage satisfied the requirements of an in-car driving evaluation;

FIG. 8 is a process flow diagram illustrating an example stepwise completion of an in-car driving evaluation;

FIG. 9 is a process flow diagram illustrating an example stepwise generation of an in-car driving evaluation certificate;

FIG. 10A is a process flow diagram illustrating an example stepwise process of a user of the system obtaining automobile insurance within the mobile application or from a teen driver insurance score; and

FIG. 10B is a process flow diagram illustrating an example stepwise generation of a proprietary teen insurance score.

Example implementations are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the disclosed technology. Accordingly, the following implementations are set forth without any loss of generality to, and without imposing limitations upon, the claimed subject matter. With regard to certain terminology used herein, it is to be understood that the terms “teenage driver”, “driver”, “individual”, and “user” may be used interchangeably to refer to the same entity or aspect of a process step. It is also to be understood that the terms “mobile application”, “application”, and “application software” may be used interchangeable to refer to the same structure or item. The term “telematics” refers primarily to vehicle telematics, which involves vehicle onboard communication services and applications that communicate with one another using GPS receivers and other telematics devices. The most common application of this technology is vehicle tracking.

The examples discussed herein are examples only and are provided to assist in the explanation of the apparatuses, devices, systems, and methods described herein. None of the features or components shown in the drawings or discussed below should be taken as required for any specific implementation of any of these the apparatuses, devices, systems or methods unless specifically designated as such. For ease of reading and clarity, certain components, modules, or methods may be described solely in connection with a specific Figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

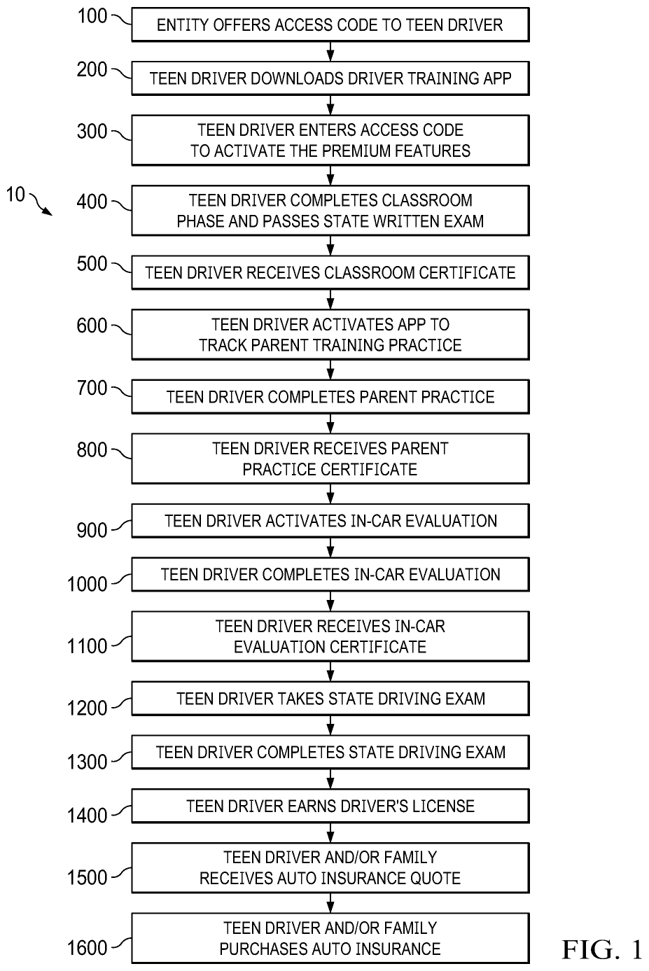

FIG. 1 is a process flow diagram illustrating an example main workflow 10 for lowering costs and improving access to driver education and automobile insurance for teen drivers, using telematics and application technology that can be used with mobile devices and in-vehicle application systems and displays. In process block 100 of main workflow 10, an entity offers an access code to a teen driver to be used with the application. The entity can include an insurance agent, a marking company, a high school, or a similar carrier. After the access code is offered, the user transitions to process block 200, wherein the user downloads the driver training application. The training application can be a downloadable mobile application or an in-vehicle application. Once the application is downloaded, the driver enters the access code obtained in process block 100 within the application to activate the application's premium features, as depicted in process block 300. Process block 400 illustrates a classroom learning module offered within the application and the requirement that the driver take and pass the state-specific written exam. The classroom learning module in process block 400 is set to the state-specific hour requirements for in-class instruction. Once the driver completes the classroom learning module in process block 400, the driver will receive a classroom certificate, as diagramed in process block 500. Once the driver successfully passes the state-specific written exam, the driver can activate the application in process block 600 to track their completion of supervised parent driving through a parent training practice module. The parent training practice module in process block 600 is set to the state-specific hour requirements for supervised parental driving. Once the driver completes the parent training practice module in process block 700, the driver will receive a classroom certificate, as depicted in process block 800.

With further reference to FIG. 1, main workflow 10 further includes process block 900, wherein the teen driver activates the application to evaluate their in-car driving. Once the driver completes the in-car driving evaluation in process block 900, the teen driver receives an in-car driving evaluation certificate, as shown in process block 1000. After earning the in-car evaluation certificate in process block 1000, the driver takes and completes the state-specific driving exam, as depicted in process blocks 1200 and 1300, respectively. The teen driver then earns a driver license in process block 1400 upon successful completion of the exam in process block 1300. Once the driver earns a valid driver license in process block 1400, the driver and the driver family or the driver family may receive an automobile insurance quote in process block 1500. Finally, at process block 1600, the driver and the driver family or the driver family purchase the selected automobile insurance.

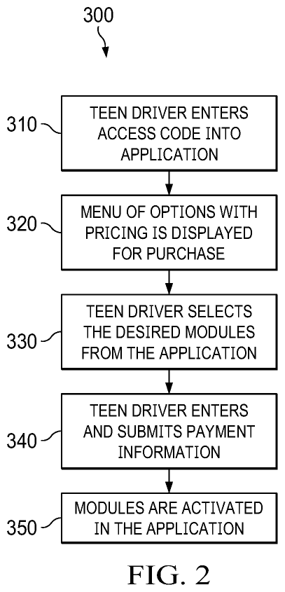

FIG. 2 is a process flow diagram illustrating the steps used by a driver to activate the application's premium features at process block 300. Firstly, in process block 310, the driver enters an access code into the application. Once the driver enters the obtained code in process block 310, a menu of various module options is displayed within the application, presenting corresponding pricing for each module as illustrated in process block 320. In process block 330, the driver selects the desired, listed module(s) from the application. A display is then presented prompting the driver to enter and submit his/her payment information, which the driver does, as depicted in process block 340. Upon entering and submitting the request payment information in process block 340, the selected modules become activated in the application through process block 350. Once the modules become activated in process block 350, the modules may be accessed by the user at their convenience.

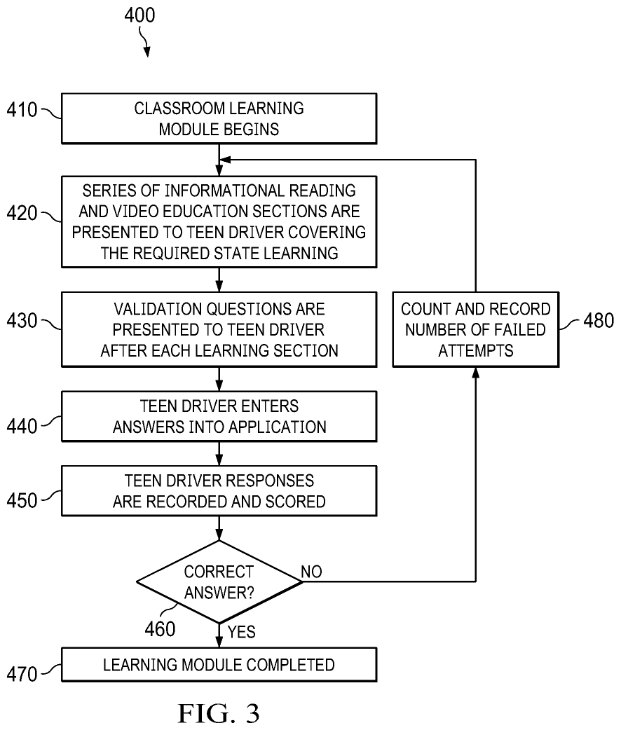

The classroom learning phase module described in process block 400 is illustrated in FIG. 3. First, the classroom learning module begins in process block 410. Next, the driver reads a series of informational readings and views educational videos in process block 420. The readings and videos in process block 420 are tailored to each state's hour and content requirement to obtain a driver license. After completing the readings and videos in process block 420, validation questions are then presented to the driver in process block 430 after each learning section to ensure driver understanding. In process block 440, the driver enters their answers to the validation questions from process block 430 within the application. The driver's answers are then recorded and scored in process block 450. Thereafter, the classroom module progresses to a decision point 460. The decision point 460 evaluates whether the driver's recorded answers in process block 450 are correct or incorrect. If the recorded answers in process block 450 are correct, the classroom leaning module is completed, as shown in process block 470. If the recorded answers in process block 450 are incorrect, the classroom learning module directs the driver back to the informational readings and educational videos of process block 420. Process block 480 counts and records the number of failed attempts. The number of failed attempts recorded in process block 480 can be used to track learning progress or used in calculating a final proprietary driving insurance score. The progression through process blocks 420-450 repeat until the driver's recorded responses in process block 450 are scored as “correct” in decision point 460. Once the driver's responses are scored “correct,” the classroom learning module is complete per process block 470.

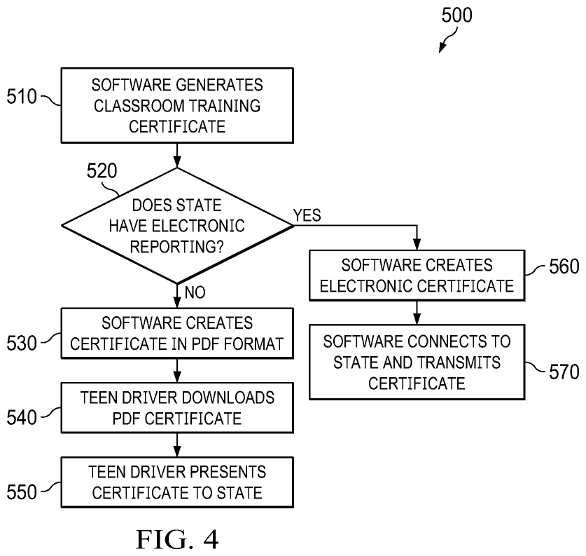

Now with reference to FIG. 4, a process flow diagram illustrates the teen driver receiving a classroom learning module completion certificate in process block 500. First, in process block 510, application software generates the classroom training certificate upon completion of the classroom learning module in process block 400. Once the certificate is generated in process block 510, a decision point 520 evaluates if the specific state uses electronic reporting of completion certificates. If the specific state uses electronic reporting, the application software creates an electronic certificate in process block 560 and then transmits the certificates to the specific state in process block 570. If the specific state does not use electronic reporting, the application software converts a certificate to a portable document format (“PDF”), or other file format, in process block 530. Once the PDF certificate is created in process block 530, the driver can download the PDF certificate in process block 540 and present the certificate to the specific state in process block 550.

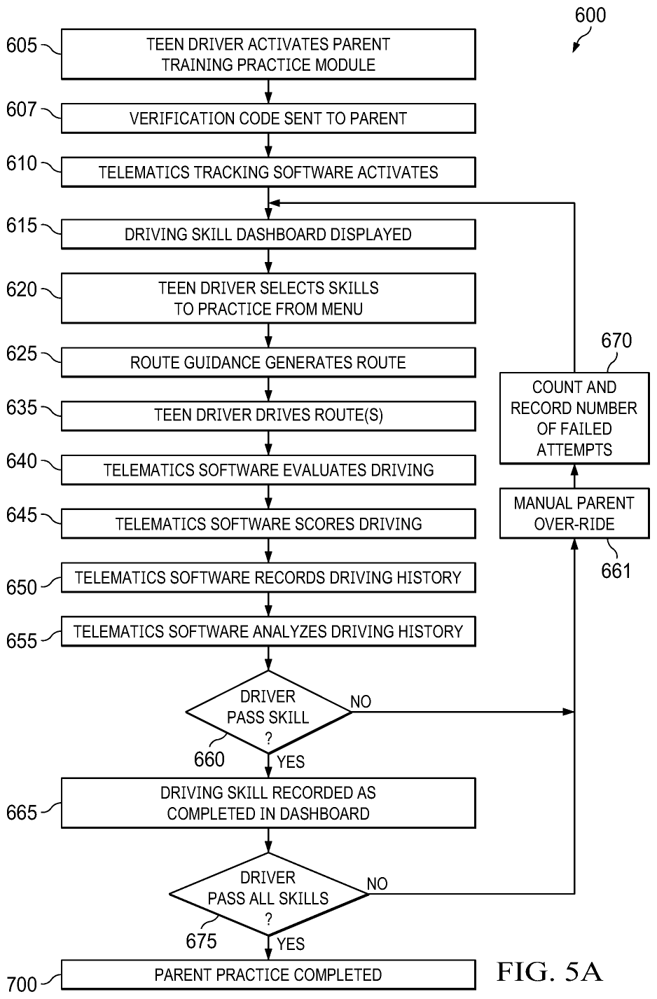

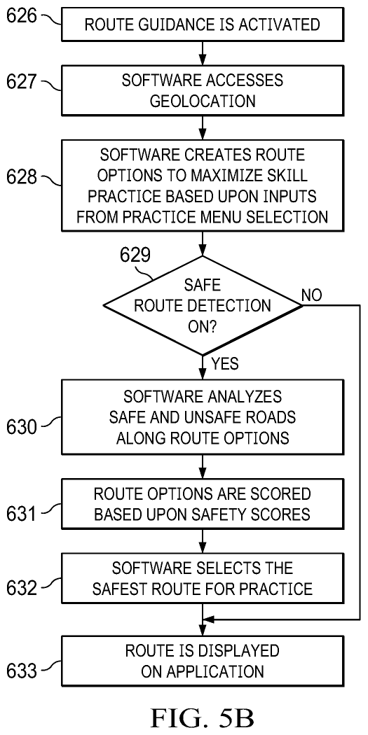

FIG. 5A is a process flow diagram illustrating progression through a parent training practice module of process block 600 within the application. To begin, the driver activates the parent training practice module in process block 605. Once the parent training module is activated in process block 605, a verification or authentication code is sent to a parent or guardian's phone, email, tablet, or other similar electronic device that requires confirmation of their presence in the vehicle, as depicted in process block 607. The verification or activation code in process block 607 ensures the driver is lawfully accompanied during driving. Thereafter, process block 610 initiates the activation of telematics tracking software. Then, a driving skill dashboard is displayed to the driver in process block 615. From the display in process block 615, the driver can select specific driving skills to practice in process block 620. The driving skills can include changing lanes and merging into traffic, passing other vehicles, entering and exiting highways, identifying of road signs and signals, keeping proper speeds, driving in school zones, using turn signals, determining driver right of ways, and braking smoothly. Once the driver selects the specific driving skill to practice in process block 620, a route guidance system in process block 625 generates a predetermined route or routes for the driver. As the driver drives the route(s) in process block 635, wherein the route(s) may include a manual or “free-form” route determined by the driver for the purpose of logging the state required practice hours, the telematics software activated in process block 610 evaluates the user's driving in process block 640 and scores the user's driving in process block 645. The telematics software then records and analyzes the driver's driving history in process blocks 650 and 655, respectively. Based on the driving history analyzed in process block 655, a decision point 660 determines whether the driver passed the specific skill selected in process block 620. If the driver passes the specific skill selected in process block 620, the specific driving skill will be recorded as “completed” in the driving skill dashboard display of process block 615, as demonstrated in process block 665. If the driver fails the specific skill selected in process block 620, the driver is returned to the driving skill dashboard display in process block 615. Process block 661 is a manual parent skill over-ride that allows the parent to manually record a driving skill as “completed” for skills that the telematics software does not capture or evaluate. Process block 670 counts and records the number of failed attempts. The number of failed attempts recorded in process block 670 can be used to track learning progress or used in calculating a final proprietary driving insurance score. Accordingly, the driver must progress through process blocks 615-655 until the decision point 660 determines the driver has passed the selected skill. Once the driver completes the selected skill in process block 665, a decision point 675 evaluates if the driver has passed all the skills displayed on the dashboard in process block 615. If the driver has completed all the displayed skills, the parent practice module is complete, as demonstrated in process block 700. If the driver has not completed all the displayed skills in process block 615, the driver is returned to the driving skill dashboard in process block 615. Process block 670 counts and records the number of failed attempts. Accordingly, the driver must progress through process blocks 615-655 and 666 and decision point 675 until the decision point 675 determines that the driver has passed all of the skills listed in progress block 615.

FIG. 5B is a process flow diagram illustrating route guidance and safe route detection within the parent training practice module of process block 600. To begin, route guidance is activated by the driver in process block 626. The application software then accesses the driver's geolocation in process block 627 and creates route options in process block 628 to maximize skill practice based on the skills selected in process block 620. Then, decision point 629 evaluates whether safe route detection is activated. If decision point 629 determines safe route detection is not activated, the generated route from process block 628 is displayed on the application, as described in process block 633. If safe route detection is activated in decision point 629, the application software then analyzes safe and unsafe roads along various route options in process block 630. The application software in process block 630 examines rates of accidents, weather and road conditions, construction and lane closures, and traffic patterns to determine the safe and unsafe roads when selecting the safest route for the driver's practice. The route options are then scored based upon their level of safety in process block 631, and the safest route is selected for driver skill practice in process block 632. Finally, the route is displayed on the application in process block 633.

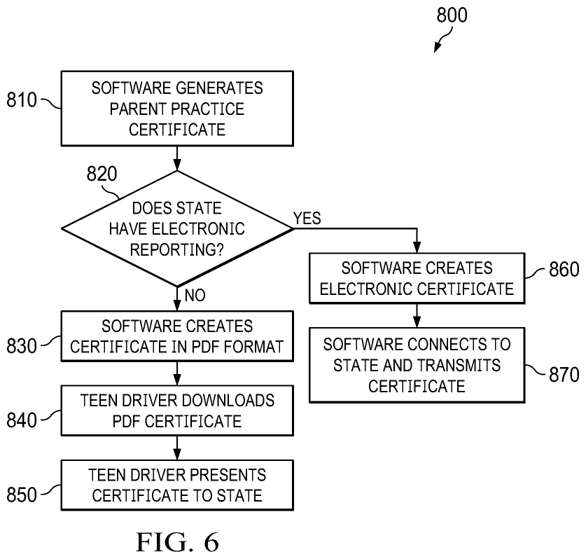

Now referring to FIG. 6, upon completion of the parent practice module in process block 700, the driver receives a parent practice module certificate of completion in process block 800. First, in process block 810, the application software generates the parent practice certificate. Once the certificate is generated in process block 810, a decision point 820 evaluates if the specific state uses electronic reporting of completion certificates. If the specific state uses electronic reporting, the application software creates an electronic certificate in process block 860 and then transmits the certificates to the specific state in process block 870. If the specific state does not use electronic reporting, the application software converts a certificate to a PDF in process block 830. Once the PDF certificate is created in process block 830, the driver can download the PDF certificate in process block 840 and present the certificate to the specific state in process block 850.

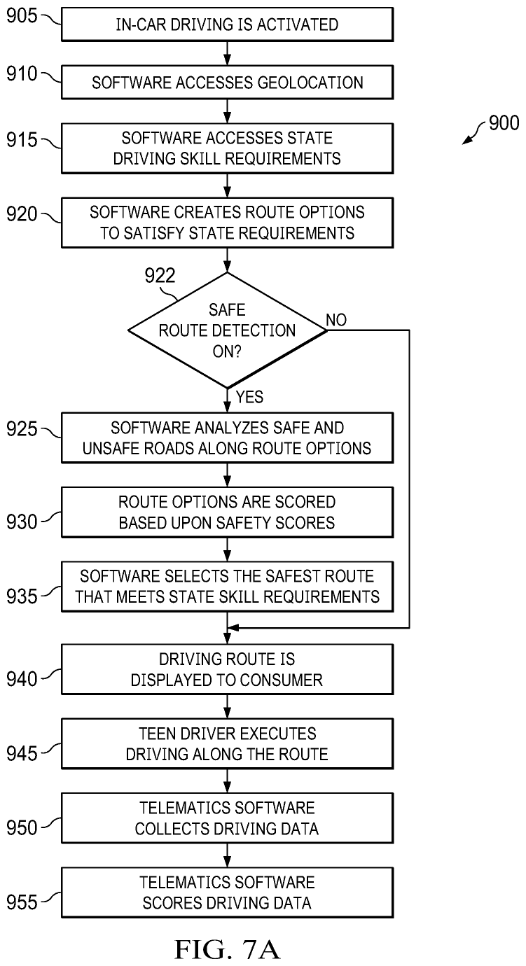

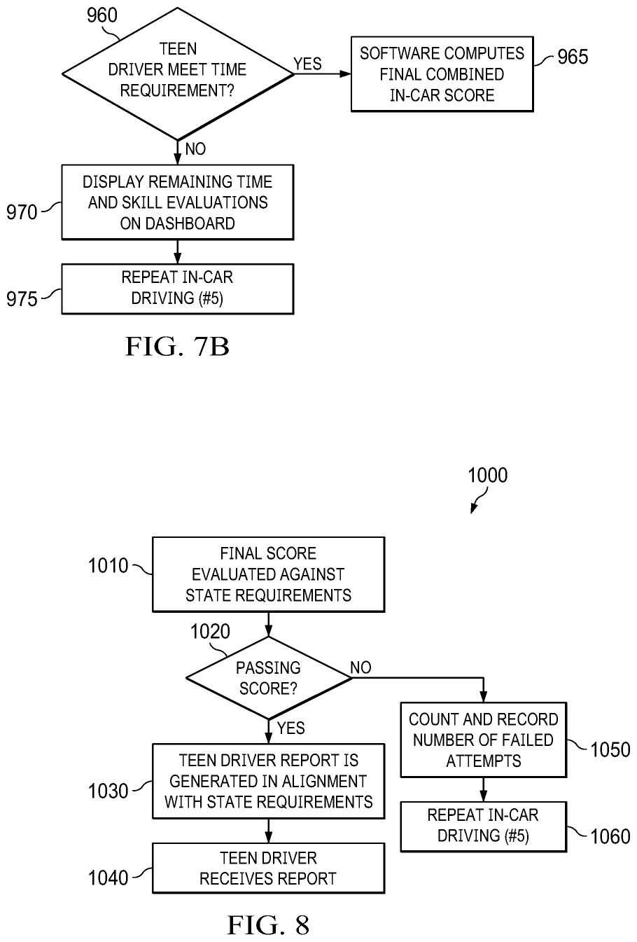

FIG. 7A is a process flow diagram illustrating an in-car driving evaluation module of process block 900. To begin, the driver activates the in-car driving module in process block 905. Next, the application software accesses the driver's geolocation in process block 910. The application software then accesses the specific state's driving skill requirements in process block 915. Based on the driving skill requirements of each state (U.S. jurisdictions) in process block 915, the application software creates various route options in process block 920 that satisfy the state's requirements. The software, when applicable, provides the driver the option to utilize safe route detection to analyze safe and unsafe roads along the various route options generated in process block 920, as shown in process block 925. Decision point 922 evaluates whether safe route detection is activated. If decision point 922 determines safe route detection is not activated, the generated route from process block 920 is displayed to the user, as described in process block 940. If safe route detection is activated in decision point 922, the application software then analyzes safe and unsafe roads along various route options in process block 925. The application software in process block 925 examines rates of accidents, weather and road conditions, construction and lane closures, and traffic patterns to determine the safe and unsafe roads when selecting the safest route for the driver's practice. The analyzed route options are then given a safety score in process block 930, and the software selects the safest routes in process block 935 that meet the state skill requirements. Thereafter, the selected driver route from process block 935 is displayed to consumer in process block 940. As the driver drives along the selected route, shown in process block 945, telematics software collects the user's driving data in process block 950. The driving data collected in process block 950 is then scored in process block 955.

FIG. 7B is a process flow diagram illustrating whether a teen satisfied the requirements of the in-car driving evaluation module of process block 900. Firstly, a decision point 960 determines whether the teen met the time requirement established by his/her state for in-car driving. If the driver satisfied the state's requirements, the application's software computes a final, combined in-car score, as shown in process block 965. If the driver did not satisfy the requirements, process block 970 displays the remaining time and skill evaluations on the user's driving skill dashboard from process block 615 in FIG. 5A. Process block 975 will then require the user to repeat the in-car driving module of process block 900 until the user satisfies the specific state's requirements.

FIG. 8 is a process flow diagram illustrating completion of the in-car driving evaluation in process block 1000. To begin, the final in-car score from process block 965 in FIG. 7B is evaluated against the specific state requirements, shown in process block 1010. Next, a decision point 1020 determines whether the final, evaluated score in process block 1010 is passing in the specific state. If the score is not passing, process block 1060 requires the driver to repeat the in-car driving module of process block 900 until the score is passing. Process block 1050 counts and records the number of failed attempts. The number of failed attempts recorded in process block 1050 can be used to track learning progress or used in calculating a final proprietary driving insurance score. If the score is passing, a teen driver report is generated in process block 1030 that aligns with specific state requirements. As demonstrated in process block 1040, the generated report from process block 1030 is then delivered to the driver.

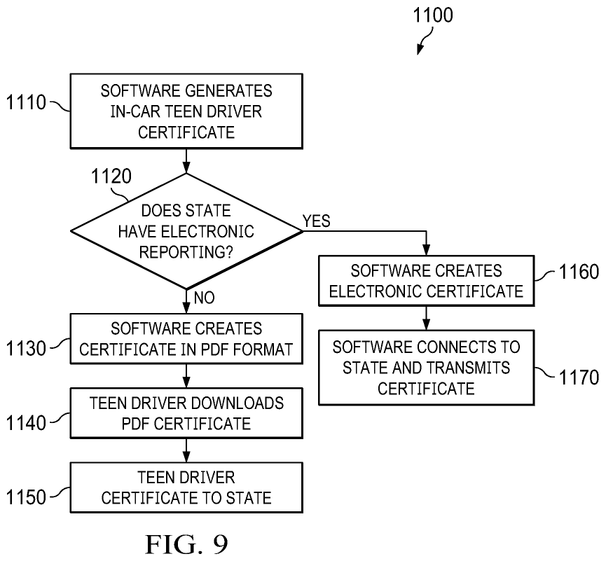

Now referring to FIG. 9, upon completion of the in-car driving evaluation module in process block 1000, the driver receives an in-car driving evaluation module certificate of completion in process block 1100. First, in process block 1110, the application software generates the in-car evaluation certificate. Once the certificate is generated in process block 1110, a decision point 1120 evaluates if the specific state uses electronic reporting of completion certificates. If the specific state uses electronic reporting, the application software creates an electronic certificate in process block 1160 and then transmits the certificates to the specific state in process block 1170. If the specific state does not use electronic reporting, the application software converts a certificate to a PDF in process block 1130. Once the PDF certificate is created in process block 1130, the driver can download the PDF certificate in process block 1140 and present the certificate to the specific state in process block 1150.

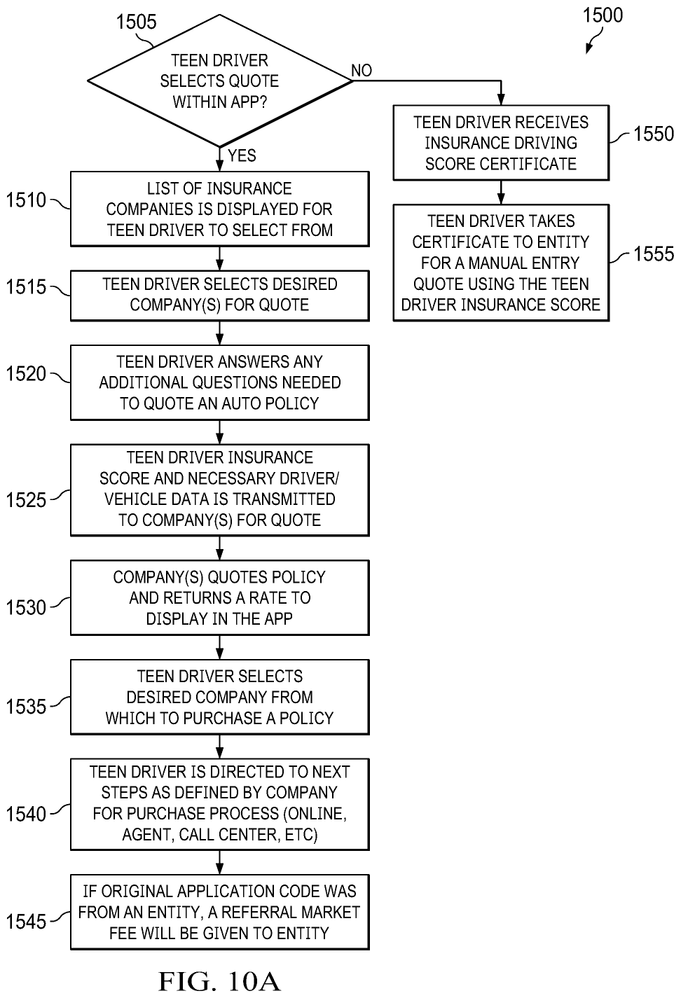

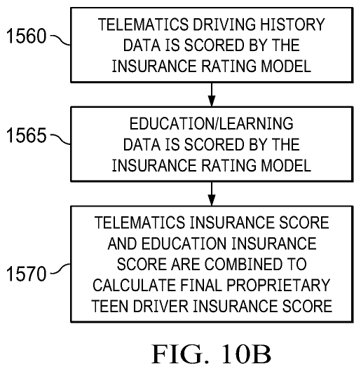

FIG. 10A is a process flow diagram illustrating a teen obtaining automobile insurance within the application or from a teen driver insurance score. Once the driver takes and passes a state driving exam and is issued a driver license in process blocks 1200, 1300, and 1400, respectively, the driver and the driver's family or the driver's family may receive an automobile insurance quote in process block 1500. To begin, a decision point 1505 analyzes whether the driver selected the insurance quote within the application. If the driver did not select the insurance quote within the application, the driver will receive an insurance driving score certificate, as illustrated in process block 1550. Thereafter, in process block 1555, the driver can take the driving score certificate to an entity or insurance agent for manual entry of the insurance quote using the driver's proprietary teen driver insurance score, further described in FIG. 10B. If the driver did select insurance quotes within the application, process block 1510 will display a list of insurance companies for the driver to select from. Thereafter, in process block 1515, the driver will select his/her desired company(s) for an insurance quote. Next, the driver will answer any additional questions needed to quote an automobile insurance policy, as shown in process block 1520. Further, the driver's proprietary teen driver insurance score and necessary vehicle and, or, driver data is transmitted to the company(s) in process block 1525 to prepare the insurance quote. The company(s) will then provide the policy quote and rate to the driver through the application in process block 1530, and the driver may then select from the company(s) which insurance policy to purchase, shown in process block 1535. Process block 1540 will then direct the driver as to the next steps for purchasing the policy selected in process block 1535. Finally, as described in process block 1545, if the code the driver entered in process block 100 was from an entity or insurance agent, a referral market fee will be given to the entity or agent.

FIG. 10B is a process flow diagram illustrating the generation of a proprietary teen insurance score. Firstly, in process block 1560, the telematics driving history data of process blocks 600 and 900 is scored by an insurance rating model. Next, in process block 1565, the education and learning data of process block 400 is scored by the insurance rating model. Finally, in process block 1570, the scored telematics history of process block 1560 is combined with the scored telematics education data of process block 1565 to yield a final proprietary teen driver insurance score.

All literature and similar material cited in this application, including, but not limited to, patents, patent applications, articles, books, treatises, and web pages, regardless of the format of such literature and similar materials, are expressly incorporated by reference in their entirety. Should one or more of the incorporated references and similar materials differs from or contradicts this application, including but not limited to defined terms, term usage, described techniques, or the like, this application controls.

As previously stated and as used herein, the singular forms “a,” “an,” and “the,” refer to both the singular as well as plural, unless the context clearly indicates otherwise. The term “comprising” as used herein is synonymous with “including,” “containing,” or “characterized by,” and is inclusive or open-ended and does not exclude additional, unrecited elements or method steps. Although many methods and materials similar or equivalent to those described herein can be used, particular suitable methods and materials are described herein. Unless context indicates otherwise, the recitations of numerical ranges by endpoints include all numbers subsumed within that range. Furthermore, references to “one implementation” are not intended to be interpreted as excluding the existence of additional implementations that also incorporate the recited features. Moreover, unless explicitly stated to the contrary, implementations “comprising” or “having” an element or a plurality of elements having a particular property may include additional elements whether or not they have that property.

The terms “substantially” and “about”, if or when used throughout this specification describe and account for small fluctuations, such as due to variations in processing. For example, these terms can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%, and/or 0%.

Underlined and/or italicized headings and subheadings are used for convenience only, do not limit the disclosed subject matter, and are not referred to in connection with the interpretation of the description of the disclosed subject matter. All structural and functional equivalents to the elements of the various implementations described throughout this disclosure that are known or later come to be known to those of ordinary skill in the art are expressly incorporated herein by reference and intended to be encompassed by the disclosed subject matter. Moreover, nothing disclosed herein is intended to be dedicated to the public regardless of whether such disclosure is explicitly recited in the above description.

There may be many alternate ways to implement the disclosed technology. Various functions and elements described herein may be partitioned differently from those shown without departing from the scope of the disclosed technology. Generic principles defined herein may be applied to other implementations. Different numbers of a given module or unit may be employed, a different type or types of a given module or unit may be employed, a given module or unit may be added, or a given module or unit may be omitted.

Regarding this disclosure, the term “a plurality of” refers to two or more than two. Unless otherwise clearly defined, orientation or positional relations indicated by terms such as “upper” and “lower” are based on the orientation or positional relations as shown in the Figures, only for facilitating description of the disclosed technology and simplifying the description, rather than indicating or implying that the referred devices or elements must be in a particular orientation or constructed or operated in the particular orientation, and therefore they should not be construed as limiting the disclosed technology. The terms “connected”, “mounted”, “fixed”, etc. should be understood in a broad sense. For example, “connected” may be a fixed connection, a detachable connection, or an integral connection, a direct connection, or an indirect connection through an intermediate medium. For an ordinary skilled in the art, the specific meaning of the above terms in the disclosed technology may be understood according to specific circumstances.

It should be appreciated that all combinations of the foregoing concepts and additional concepts discussed in greater detail herein (provided such concepts are not mutually inconsistent) are contemplated as being part of the disclosed technology. In particular, all combinations of claimed subject matter appearing at the end of this disclosure are contemplated as being part of the technology disclosed herein. While the disclosed technology has been illustrated by the description of example implementations, and while the example implementations have been described in certain detail, there is no intention to restrict or in any way limit the scope of the appended claims to such detail. Additional advantages and modifications will readily appear to those skilled in the art. Therefore, the disclosed technology in its broader aspects is not limited to any of the specific details, representative devices and methods, and/or illustrative examples shown and described. Accordingly, departures may be made from such details without departing from the spirit or scope of the general inventive concept.

What is claimed:

1. A system for improving access to teen driver education and automobile insurance using telematics technology, comprising:
(a) a downloadable driver training application wherein a driver selects and submits a fee for training modules offered within the application, wherein the driver enters an access code to access the modules;
(b) an in-classroom learning module within the application that grants an in-classroom training certificate upon completion, wherein the driver is presented with readings, videos, and validation questions that are specific to a jurisdictional in-classroom hour and content requirement needed to obtain a driver license;
(c) a parent training practice module within the application specific to the jurisdiction's hour requirement for supervised driving that grants a parent practice certificate upon completion, wherein telematics tracking software evaluates and scores the driver's driving in real time along a generated route for a driver-selected practice skill;
(d) an in-car driving module within the application specific to the jurisdiction's hour requirement for in-car driving that grants an evaluation certificate upon completion, wherein the telematics tracking software collects and scores the driver's driving data in real time along the generated route;
(e) a jurisdictional driving exam that is completed by the driver;
(f) a jurisdictional driver license that is earned by the driver; and
(g) an automobile insurance quote generated from a proprietary teen driver insurance score that is calculated based on the driver's performance in the in-classroom leaning module or from the driving data collected by the telematics tracking software and received by the drive.

2. The system of claim 1, wherein the training application is a downloadable mobile application or an in-vehicle application systems.

3. The system of claim 1, wherein the validation questions of the in-classroom learning module are recorded and scored within the application, wherein the readings, videos, and validation questions repeat if the driver answers the validation questions incorrectly.

4. The system of claim 1, wherein the in-classroom training certificate of the in-classroom learning module is electronically transmitted to the jurisdiction if the jurisdiction participates in electronic reporting, or if the jurisdiction does not participate in electronic reporting, the in-classroom training certificate is generated into downloadable PDF format for the driver to submit to the jurisdiction.

5. The system of claim 1, wherein the telematics tracking software in the parent training practice module records and analyzes the driver's driving history and determines whether the driver obtained a passing score for the selected practice skill, wherein the selected practice skill is recorded as “complete” if the driver obtained the passing score, wherein the driver must repeat the selected practice skill if the driver did not obtain the passing score.

6. The system of claim 1, wherein the generated route in the parent training practice module can use safe route detection, wherein, the application analyzes safe and unsafe roads along route options, scores the route options based upon their safety, and selects the safest route for the driver's practice.

7. The system of claim 6, wherein the application examines rates of accidents, weather and road conditions, construction and lane closures, and traffic patterns to determine the safe and unsafe roads when selecting the safest route for the driver's practice.

8. The system of claim 1, wherein the parent practice certificate of the parent training practice module is electronically transmitted to the jurisdiction if the jurisdiction participates in electronic reporting, or if the jurisdiction does not participate in electronic reporting, the parent practice certificate is generated into downloadable PDF format for the driver to submit to the jurisdiction.

9. The system of claim 1, wherein the in-car driving module utilizes the safe route detection to generate the safest driving route for the driver.

10. The system of claim 1, wherein the telematics tracking software's score in the in-car driving module is evaluated against the jurisdiction's requirements for a passing result, wherein a teen driver report is generated in alignment with the jurisdiction's requirements if the telematics tracking software's score is passing, wherein the driver must repeat the in-car driving module if the score is not passing.

11. The system of claim 1, wherein the evaluation certificate of the in-car driving module is electronically transmitted to the jurisdiction if the jurisdiction participates in electronic reporting, or if the jurisdiction does not participate in electronic reporting, the evaluation certificate is generated into downloadable PDF format for the driver to submit to the jurisdiction.

12. The system of claim 1, wherein the automobile insurance quote can be selected by the driver within the application from a list of insurance companies, wherein the driver selects their desired company(s) for the quote, wherein the proprietary teen driver insurance score and the driver's vehicle data is transferred to the company(s), wherein the company(s) quote a policy and issue a rate that is displayed within the application, wherein the driver selects their desired company and purchases the automobile insurance.

13. The system of claim 1, wherein a referral fee is administered to an entity if the access code was supplied by the entity.

14. A method for improving access to teen driver education and automobile insurance using telematics technology, comprising:
(a) downloading a driver training application, wherein a driver selects and submits a fee for training modules offered within the application, wherein the driver enters an access code to access the modules;
(b) activating an in-classroom learning module in the application that grants an in-classroom training certificate upon completion, wherein the driver is presented with readings, videos, and validation questions that are specific to a jurisdictional in-classroom hour and content requirement needed to obtain a driver license;
(c) activating a parent training practice module in the application specific to the jurisdiction's hour requirement for supervised driving that grants a parent practice certificate upon completion, wherein telematics tracking software evaluates and scores the driver's driving in real time along a generated route for a driver-selected practice skill;
(d) activating an in-car driving module in the application specific to the jurisdiction's hour requirement for in-car driving that grants an evaluation certificate upon completion, wherein the telematics tracking software collects and scores the driver's driving data in real time along the generated route;
(e) completing the jurisdiction's driving exam;
(f) earning the jurisdiction's driver license; and
(g) receiving an automobile insurance quote generated from a proprietary teen driver insurance score that is calculated by the driver's performance in the in-classroom leaning module or from the driving data collected by the telematics tracking software.

15. The method of claim 14, wherein the training application is a downloadable mobile application or an in-vehicle application systems.

16. The method of claim 14, wherein the validation questions of the in-classroom learning module are recorded and scored within the application, wherein the readings, videos, and validation questions repeat if the driver answers the validation questions incorrectly.

17. The method of claim 14, wherein the in-classroom training certificate of the in-classroom learning module is electronically transmitted to the jurisdiction if the jurisdiction participates in electronic reporting, or if the jurisdiction does not participate in electronic reporting, the in-classroom training certificate is generated into downloadable PDF format for the driver to submit to the jurisdiction.

18. The method of claim 14, wherein the telematics tracking software in the parent training practice module records and analyzes the driver's driving history and determines whether the driver obtained a passing score for the selected practice skill, wherein the selected practice skill is recorded as “complete” if the driver obtained the passing score, wherein the driver must repeat the selected practice skill if the driver did not obtain the passing score.

19. The method of claim 14, wherein the generated route in the parent training practice module can use safe route detection, wherein, the application analyzes safe and unsafe roads along route options, scores the route options based upon their safety, and selects the safest route for the driver's practice.

20. The method of claim 19, wherein the application examines rates of accidents, weather and road conditions, construction and lane closures, and traffic patterns to determine the safe and unsafe roads when selecting the safest route for the driver's practice.

21. The method of claim 14, wherein the parent practice certificate of the parent training practice module is electronically transmitted to the jurisdiction if the jurisdiction participates in electronic reporting, or if the jurisdiction does not participate in electronic reporting, the parent practice certificate is generated into downloadable PDF format for the driver to submit to the jurisdiction.

22. The method of claim 14, wherein the in-car driving module utilizes the safe route detection to generate the safest driving route for the driver.

23. The method of claim 14, wherein the telematics tracking software's score in the in-car driving module is evaluated against the jurisdiction's requirements for a passing result, wherein a teen driver report is generated in alignment with the jurisdiction's requirements if the telematics tracking software's score is passing, wherein the driver must repeat the in-car driving module if the score is not passing.

24. The method of claim 14, wherein the evaluation certificate of the in-car driving module is electronically transmitted to the jurisdiction if the jurisdiction participates in electronic reporting, or if the jurisdiction does not participate in electronic reporting, the evaluation certificate is generated into downloadable PDF format for the driver to submit to the jurisdiction.

25. The method of claim 14, wherein the automobile insurance quote can be selected by the driver within the application from a list of insurance companies, wherein the driver selects their desired company(s) for the quote, wherein the proprietary teen driver insurance score and the driver's vehicle data is transferred to the company(s), wherein the company(s) quote a policy and issue a rate that is displayed within the application, wherein the driver selects their desired company and purchases the automobile insurance.

26. The method of claim 14, wherein a referral fee is administered to an entity if the access code was supplied by the entity.

27. A method for lowering the costs of teen driver education and automobile insurance using telematics technology, comprising:
(a) downloading a driver training application, wherein a driver selects and submits a fee for training modules offered within the application, wherein the driver enters an access code to access the modules;
(b) activating an in-classroom learning module in the application that grants an in-classroom training certificate upon completion, wherein the driver is presented with readings, videos, and validation questions that are specific to a jurisdiction's in-classroom hour and content requirement needed to obtain a driver license, wherein the in-classroom training certificate is electronically transmitted to the jurisdiction if the jurisdiction participates in electronic reporting, or if the jurisdiction does not participate in electronic reporting, the in-classroom training certificate is generated into downloadable PDF format for the driver to submit to the jurisdiction;
(c) activating a parent training practice module in the application specific to the jurisdiction's hour requirement for supervised driving that grants a parent practice certificate upon completion, wherein telematics tracking software evaluates and scores the driver's driving in real time along a generated route for a driver-selected practice skill, wherein the parent practice certificate is electronically transmitted to the jurisdiction if the jurisdiction participates in electronic reporting, or if the jurisdiction does not participate in electronic reporting, the parent practice certificate is generated into downloadable PDF format for the driver to submit to the jurisdiction;
(d) activating an in-car driving module in the application specific to the jurisdiction's hour requirement for in-car driving that grants an evaluation certificate upon completion, wherein the telematics tracking software collects and scores the driver's driving data in real time along the generated route, wherein the evaluation certificate is electronically transmitted to the jurisdiction if the jurisdiction participates in electronic reporting, or if the jurisdiction does not participate in electronic reporting, the evaluation certificate is generated into downloadable PDF format for the driver to submit to the jurisdiction;
(e) completing the jurisdiction's driving exam;
(f) earning the jurisdiction's driver license; and
(g) receiving an automobile insurance quote generated from a proprietary teen driver insurance score that is calculated by the driver's performance in the in-classroom leaning module or from the driving data collected by the telematics tracking software.

28. The method of claim 27, wherein the training application is a downloadable mobile application or an in-vehicle application systems.

29. The method of claim 27, wherein the validation questions of the in-classroom learning module are recorded and scored within the application, wherein the readings, videos, and validation questions repeat if the driver answers the validation questions incorrectly.

30. The method of claim 27, wherein the telematics tracking software in the parent training practice module records and analyzes the driver's driving history and determines whether the driver obtained a passing score for the selected practice skill, wherein the selected practice skill is recorded as “complete” if the driver obtained the passing score, wherein the driver must repeat the selected practice skill if the driver did not obtain the passing score.

31. The method of claim 27, wherein the generated route in the parent training practice module can use safe route detection, wherein, the application analyzes safe and unsafe roads along route options, scores the route options based upon their safety, and selects the safest route for the driver's practice.

32. The method of claim 31, wherein the application examines rates of accidents, weather and road conditions, construction and lane closures, and traffic patterns to determine the safe and unsafe roads when selecting the safest route for the driver's practice.

33. The method of claim 27, wherein the parent training practice module utilizes the driver's geolocation.

34. The method of claim 27, wherein the in-car driving module utilizes the safe route detection to generate the safest driving route for the driver.

35. The method of claim 27, wherein the telematics tracking software's score in the in-car driving module is evaluated against the jurisdiction's requirements for a passing result, wherein a teen driver report is generated in alignment with the jurisdiction's requirements if the telematics tracking software's score is passing, wherein the driver must repeat the in-car driving module if the score is not passing.

36. The method of claim 27, wherein the automobile insurance quote can be selected by the driver within the application from a list of insurance companies, wherein the driver selects their desired company(s) for the quote, wherein the proprietary teen driver insurance score and the driver's vehicle data is transferred to the company(s), wherein the company(s) quote a policy and issue a rate that is displayed within the application, wherein the driver selects their desired company and purchases the automobile insurance.

37. The method of claim 27, wherein a referral fee is administered to an entity if the access code was supplied by the entity.
